(19) United States
(12) Patent Application Publication
(10) Pub. No.: US 2026/0322639 A1
(43) Pub. Date: Oct. 15, 2026

(54) OVERLAY INTERNET PROTOCOL MULTICAST STREAMS OVER A MULTI-AREA VIRTUAL NETWORK

(71) Applicant: Extreme Networks, Inc., San Jose, CA (US)

(72) Inventors: Constantin BARCARU, Brasov (RO); Roger LAPUH, Uesslingen (CH)

(73) Assignee: Extreme Networks, Inc., San Jose, CA (US)

(21) Appl. No.: 19/174,353

(22) Filed: Apr. 9, 2025

(51) Int. Cl. H04L 12/18; H04L 45/12; H04L 69/325

(52) U.S. Cl. CPC H04L 12/18; H04L 45/12; H04L 69/325

(57) ABSTRACT

Provided herein are systems and methods for facilitating overlay Internet Protocol (IP) multicast streams over an underlay multi-area network. A multi-area network can have an edge node that receives an overlay packet of a multicast stream from a host device, encapsulates the overlay packet into an underlay packet based on a layer 3 virtual network, and forwards the underlay packet to a set of end nodes based on a created shortest-path forwarding tree. End nodes can de-encapsulate the overlay packet so that it can be forwarded to a set of receiving devices. The multi-area network can also have one or more inter-area routers that reside between neighboring underlay network areas. An inter-area router performs operations related to routing an underlay packet corresponding to an overlay IP multicast stream from one underlay network area to a neighboring underlay network area.

This application is related to U.S. Patent Application No. ________ titled APPARATUS AND METHOD FOR VIRTUAL NETWORK SERVICES USING A SINGLE-AREA UNDERLAY NETWORK filed herewith (Attorney Docket No. 4264.7490000) and U.S. Patent Application No. ________ titled SHORTEST PATH BRIDGING AND ROUTING (SPBX) IN MULTI-AREA filed herewith (Attorney Docket No. 4264.7500000), which are herein incorporated by reference in their entireties.

### FIELD

This disclosure relates generally to facilitating overlay Internet Protocol (IP) multicast streams over an underlay multi-area network. For example, some aspects of this disclosure relate to an edge node receiving an overlay packet of a multicast stream from a host device, encapsulating the overlay packet into an underlay packet based on a layer 3 virtual network, and forwarding the underlay packet based on a shortest-path forwarding tree. In some aspects, this disclosure relates to an inter-area router residing between neighboring underlay network areas. The inter-area router performs operations related to routing an underlay packet corresponding to an overlay IP multicast stream from one underlay network area to a neighboring underlay network area.

### BACKGROUND

Contemporary multi-tenant enabled network underlay solutions struggle to accommodate Internet Protocol (IP) multicast streams originating from an overlay network environment. For example, many contemporary multi-area network fabrics are based on Ethernet Virtual Private Network (EVPN) technologies. While accommodating overlay IP multicast streams within an EVPN fabric is possible, a significant number of helper protocols are required for its implementation. This makes multi-area network fabric configurations cumbersome to implement and computationally expensive to maintain. Additionally, many contemporary multi-tenant enabled network underlay solutions are not highly scalable. The required high number of helper protocols hinders the multi-area network fabric from accommodating a growing number of users, devices, and data entering the network in a computationally efficient manner.

Furthermore, developments in co-dependent technological fields have further hindered the effectiveness of contemporary multi-tenant enabled network underlay solutions. For example, modern silicon chipsets are less suited towards EVPN-based fabric solutions. New silicon chipsets and corresponding application-specific integrated circuits (ASICs) have higher processing speeds and greater networking functionality compared to prior silicon chipset technologies. As a result, contemporary multi-tenant enabled network underlay solutions are not able to fully maximize the scalability modern ASICs provide.

As a result, systems, methods, and/or computer programs are needed to implement multi-area network fabrics that are highly scalable and maximize the capabilities of modern ASIC technologies for overlay IP multicast streams.

### SUMMARY

Provided herein are system, method, and/or computer program aspects, and/or combinations and sub-combinations thereof, which facilitate overlay Internet Protocol (IP) multicast streams over an underlay multi-area network in accordance with Shortest Path Bridging and Routing using IP-based encapsulation of data traffic (SPBX).

System and methods for facilitating overlay IP multicast streams over a multi-area SPBX network may include multiple network areas configured as underlay subnets that manage one or more nodes. In some aspects, a node as discussed in this disclosure can include a fabric node and/or a network node such as, but not limited to, a connection point inside and/or at the boundary of a network that can receive, transmit, create, and/or store data and/or other information. Some non-limiting examples of a node can include computers, routers, gateways, modems, printers, scanners, TVs, smart phones, Internet of Things (IoT) devices, bridges, switches, and the like. In some aspects, a host as discussed in this disclosure can include a personal computer (PC), a server, connected devices, TVs, smart phones.

In some aspects, the multi-area SPBX network may be implemented in conjunction with an IP-based data plane and a single control plane for bridging and routing overlay IP multicast streams. In some aspects, the data plane may be an IPv4 or IPv6 data plane. The data plane may be programmed such that every IP multicast packet can be forwarded to reach one or more end nodes in the shortest network path and avoid looping. In some aspects, the control plane is a single Intermediate System to Intermediate System (ISIS or IS-IS) routing protocol.

In some aspects, the multi-area SPBX network has a first area with a first set of network nodes and a second area with a second set of network nodes outside of the first area. This multi-area fabric is exemplary. The multi-area SPBX network is not limited to having two network areas and may be segmented into any number of distinct network areas. In some aspects, the network areas may be configured as distinct underlay IP subnets grouped by a unique range of IP addresses.

System and methods for forwarding an overlay packet of a multicast stream over a multi-area network include receiving an overlay packet of the multicast stream from a host device by an edge node in a first set of network nodes of a first area. The edge node may encapsulate the overlay packet into an underlay packet. In this disclosure, underlay packet, underlay multicast packet, and other comparable terms may be used interchangeably. In some aspects, the encapsulation is based on a layer 3 virtual network. The edge node may create a shortest-path forwarding (SPF) tree to one or more receiving devices. The SPF tree may include a root node corresponding to the edge node, a set of forwarding nodes among the first and second sets of network nodes, and a set of end nodes in the first and second sets of network nodes. In some aspects, the edge node forwards, using the set of forwarding nodes, the underlay packet to the set of end nodes.

In some aspects, the edge node encapsulates the overlay packet into an underlay packet by adding an underlay header to the overlay packet. In some aspects, adding the underlay header may also mean prepending the underlay header. The underlay header may include a source Media Access Control (MAC) address of the edge node, a source Internet Protocol (IP) address of the edge node, a destination MAC address of the multicast stream, a destination IP address of the multicast stream, a virtual local area network (VLAN) value derived by the edge node, and a virtual network identifier (VNI) value derived by the edge node. In some aspects, the source MAC address may be a backbone MAC source address (BMAC-SA) of the edge node. In some aspects, the source IP address may be a backbone underlay source IP address (BIP-SA). In some aspects, the destination multicast MAC address of the multicast stream may be a backbone MAC destination address (BMAC-DA). In some aspects, the destination IP address of the multicast stream may be a backbone underlay destination address (BIP-DA).

In some aspects, the edge node assigns a nickname and the VNI value derived by the edge node to the SPF tree. The nickname may correspond to a predefined number of least significant bits of an IP address of the edge node. In some aspects, the predefined number of least significant bits may be 20 bits. The nicknames of the multi-area network may be grouped based on the IP subnet address assigned an area.

In some aspects, the edge node, using the set of forwarding nodes, bridges the underlay packet to perform intra-area forwarding operations among the first and second sets of network nodes based on the nickname and VNI value assigned to the SPF tree.

In some aspects, the edge node assigns an underlay Source Group VLAN (SGV) value corresponding to the multicast stream. The underlay SGV value may be a tuple comprising a source IP address of the edge node receiving the multicast stream, a reserved group IP address reflecting the VNI derived by the edge node, and a VLAN value of the edge node, such as a backbone VLAN (BVLAN). In some aspects, the edge node, using the set of forwarding nodes, may route the underlay packet to perform intra-area forwarding operations among the first and second sets of network nodes based on the underlay SGV value assigned to the SPF tree.

In some aspects, the edge node announces the overlay multicast stream into an ISIS link-state database of the first area via a Type-Length-Value (TLV) encoding scheme. The edge node may announce the multicast stream based on an overlay SGV value. The overlay SGV value may be a tuple represented by the source IP address of the host device sending the multicast stream, a destination IP address corresponding to the multicast group, and a network identifier based on virtual routing and forwarding. Based on announcing the multicast stream into the ISIS link-state database of the first area, the edge node may determine one or more inter-area routers capable of routing the underlay packet into the second area. The edge node, using the forwarding nodes, may forward the underlay packet to the one or more inter-area routers.

In some aspects, the edge node receives a second overlay packet of a second multicast stream from a second host device. The edge node may encapsulate the second overlay packet into a second underlay packet based on the layer 3 virtual network. The edge node may create a second SPF tree to a set of end nodes connected to a second one or more receiving devices. The second SPF tree may contain a second root node corresponding to the edge node, a second set of forwarding nodes among the first and second sets of network nodes, and a second set of end nodes in the first and second sets of network nodes. In some aspects, the edge node may assign its respective nickname and a second VNI value or a second underlay SGV value to the second SPF tree.

System and methods for forwarding an underlay packet of a multicast stream from a first area of network nodes to a second area of network nodes outside of the first area includes an inter-area router residing between the first and second areas that receives an underlay packet of the multicast stream. The underlay packet may include an underlay header containing the elements described above. The inter-area router may change the source MAC address of the underlay packet to the MAC address corresponding to the inter-area router. The inter-area router may transmit the underlay packet to a network node in the second area of network nodes or another inter-area router.

In some aspects, the inter-area router determines that the multicast stream was introduced into the first area of network nodes. Based on a determination that the multicast stream was introduced into the first area of network nodes, the inter-area router may announce the multicast stream, via a TLV encoding scheme, to a link-state database (LSDB) of the second area of network nodes in the ISIS-configured control plane. For example, the inter-area router may announce the multicast stream based on the overlay SGV value reflecting the multicast stream. The inter-area router may advertise, to an LSDB of the first area of network nodes, that the inter-area router may route the underlay packet into the second area of network nodes.

In some aspects, the multi-area network fabric contains a third area of network nodes outside of the first and second areas. Based on determining that the previous multicast stream was introduced into the first area, the inter-area router may re-announce the multicast stream, via the TLV encoding scheme, into an LSDB of the third area in the ISIS-configured control plane. For example, the inter-area router may re-announce the multicast stream based on the overlay SGV value reflecting the multicast stream. In some aspects, the inter-area router may advertise, to the LSDB of the first area of network nodes, a forwarding path into the third area of network nodes.

In some aspects, to advertise a forwarding path into the third area, the inter-area router may calculate a distance metric from each network node in the first area to the network nodes in the third area. The distance metric may indicate a forwarding route distance across the multi-area network. The inter-area router may input the distance metric for each network node of the first area into an ISIS LSDB of the first area. The inter-area router may determine the distance metric from a network node in the first area of network nodes to a network node in the third area of network nodes corresponds to the shortest bridged path. The shortest bridged path may reflect the SPF tree of the multi-area network.

In some aspects, the inter-area router may determine that a network node in an area outside of the originating area advertises its intention to subscribe to the multicast stream. The inter-area router may then forward the underlay packet to the subscribing node based on the BMAC-DA and VNI value or underlay SGV value corresponding to the stream.

In some aspects, the inter-area router may comprise a first LSDB in the ISIS-configured control plane corresponding to the first area of network nodes and a second LSDB in the ISIS-configured control plane corresponding to the second area of network nodes. The inter-area router may further comprise additional LSDBs corresponding to the areas which it borders.

In some aspects, the inter-area router de-increments a time-to-live (TTL) value associated with the underlay packet.

Further aspects, features, and advantages of the present disclosure, as well as the structure and operation of the various aspects of the present disclosure, are described in detail below with reference to the accompanying drawings.

### BRIEF DESCRIPTION OF THE DRAWINGS/FIGURES

The accompanying drawings, which are incorporated herein and form a part of the specification, illustrate aspects of the present disclosure and, together with the description, further serve to explain the principles of the disclosure and to enable a person skilled in the art(s) to make and use the aspects.

FIG. 1 illustrates a block diagram of an exemplary single area network, according to some aspects.

FIG. 2 illustrates a block diagram of an exemplary multi-area network, according to some aspects.

FIG. 3 illustrates a block diagram of a control plane for a multi-area network, according to some aspects.

FIG. 4A illustrates a block diagram of a multi-area network with a single overlay Internet Protocol (IP) multicast stream, according to some aspects.

FIG. 4B illustrates a block diagram of a multi-area network with multiple overlay IP multicast streams, according to some aspects.

FIG. 5 is a flow chart illustrating a method for forwarding an overlay packet from an IP multicast stream over a multi-area network, according to some aspects.

FIG. 6 is a flow chart illustrating a method for forwarding an underlay packet to an inter-area router using a link-state database in an Intermediate System to Intermediate System (ISIS) control plane, according to some aspects.

FIG. 7 is a flow chart illustrating a method for forwarding a second overlay packet from a second overlay IP multicast stream over a multi-area network, according to some aspects.

FIG. 8 is a flow chart illustrating a method for forwarding an underlay packet of an overlay IP multicast stream from a first area of network nodes into a second area of network nodes outside of the first area, according to some aspects.

FIG. 9 is a flow chart illustrating a method for forwarding an underlay packet of an overlay IP multicast stream from a first area of network nodes into second and third areas of network nodes outside of the first area.

FIG. 10 illustrates a block diagram of a general-purpose computer that can be used to perform various aspects of the present disclosure, according to some aspects.

In the drawings, like reference numbers generally indicate identical or similar elements. Additionally, the left-most digit(s) of a reference number generally identifies the drawing in which the reference number first appears.

### DETAILED DESCRIPTION

Provided herein are system, method, and/or computer program product aspects and/or combinations and sub-combinations thereof, which facilitate overlay Internet Protocol (IP) multicast streams over a multi-area network.

The process of packet forwarding may define the effectiveness of multi-area network fabrics. Effective network fabrics can provide highly scalable multi-tenant solutions and implementations. A highly scalable multi-area network fabric is more capable of handling increased network traffic by enlarging the network in such a way that does not sacrifice the performance or stability of the network. Additionally, effective network fabrics require flexibility to adapt to changes in topology, especially in large multi-area deployments. Flexible network architecture can accommodate modifications of network areas such as node movement or area redistributions in a computationally efficient and streamlined process. Without a highly flexible network architecture, modifications to the network may lead to increased looping and packet loss. Moreover, highly scalable and flexible network fabrics allow for easier implementations with current application-specific integrated circuit (ASIC) technologies and service provider infrastructures. Thus, it is important to implement a network fabric capable of meeting the increased capacity demands imposed on networks and maximizing co-dependent technologies used for configuring a network fabric while maintaining a high level of performance and stability.

A network topology may be segmented into underlay and overlay networks. An underlay network may refer to the physical network infrastructure, such as Ethernet switches, nodes, routers, or a combination thereof, that forwards data packets from a host device to a receiving device. The overlay network may refer to a virtual network interconnecting end devices among the network topology.

In some aspects, a node as discussed in this disclosure can include a fabric node and/or a network node such as, but not limited to, a connection point inside and/or at the boundary of a network that can receive, transmit, create, and/or store data and/or other information. Some non-limiting examples of a node can include computers, routers, gateways, modems, printers, scanners, TVs, smart phones, Internet of Things (IoT) devices, bridges, switches, and the like. In some aspects, a host as discussed in this disclosure can include a personal computer (PC), a server, connected devices, TVs, smart phones.

Furthermore, a network topology segmented into overlay and underlay networks heavily relies on the data and control planes configured to forward a packet across the network. The data plane may refer to the network architecture that processes data transmissions between hosts. The control plane may refer to the network architecture that determines and stores routing and bridging decisions. These configuration characteristics are essential to the effectiveness of contemporary IP-based multi-tenant underlay solutions.

Contemporary IP-based multi-tenant underlay solutions struggle with native IP multicast overlay support due to legacy data and control planes configured within the multi-area network fabrics. For example, many contemporary underlay solutions are based on Ethernet Virtual Private Network (EVPN) configurations. EVPNs may generally use Multiprotocol-Border Gateway Protocol and/or Protocol Independent Multicast-based control planes. Network fabrics utilizing these types of configurations may not be able to build their own routing tables or may require additional networking protocols to build the shortest-path forwarding trees necessary to forward multicast traffic. Thus, the control planes of contemporary multi-tenant underlay solutions may require additional routing protocols that are computationally inefficient and cumbersome to implement. As a result, contemporary IP-based multi-tenant underlay solutions are not appropriately configured and optimized to maximize shortest-path bridging and routing methodologies.

In contrast to contemporary IP-based multi-tenant underlay solutions, some aspects of this disclosure make use of an IP-based data plane and Intermediate System to Intermediate System (ISIS or IS-IS) control plane to implement shortest path bridging and routing using IP-based encapsulation of data traffic (SPBX) over a multi-area network. Specifically, the multi-area SPBX network may utilize a single ISIS protocol solution in the control plane to provide a streamlined, efficient, and less cumbersome solution for multi-area network fabric implementations. In some aspects, the ISIS control plane may program the data plane such that it can forward IP multicast overlay traffic over an underlay mesh network. Furthermore, the multi-area SPBX network may implement an IP-based data plane. In some aspects, the IP-based data plane may be based on a Virtual eXtensible Local Area Network (VXLAN), Generic Network Virtualization Encapsulation (GENEVE), or another comparable layer 3 virtualization technology.

The combination of an IP-based data plane and ISIS control plane provides a highly scalable multi-tenant, multi-area IP multicast solution supported by modern ASIC technologies and modernizes legacy solutions based on the IEEE 802.1ah networking standard. For example, the IP-based data plane may improve upon conventional multi-area network fabrics by increasing the scalability of the network. Specifically, the IP-based data plane may increase the overall capacity of individual components within the network and catalyze greater parallel processing and load balancing capabilities. Moreover, the ISIS control plane reduces the amount of helper protocols necessary to facilitate overlay IP multicast streams, advantageously reducing the computational resources needed to forward multicast packets across a multi-area network.

In some aspects, the overlay and underlay networks and the network elements contained therein may have separate IP addresses and media access control (MAC) addresses. For example, a packet or a frame of an overlay IP multicast stream may specify customer MAC source and destination addresses (CMAC-SA and CMAC-DA, respectively), a customer virtual local area network (CVLAN) value, and overlay IP source and destination addresses. The corresponding CMAC addresses, CVLAN value, and overlay IP addresses may refer to the host and multicast destination addresses detected by the access ports of the multi-area SPBX network.

In some aspects, the overlay packet may be encapsulated into an underlay packet. For example, a network node in the multi-area SPBX network may create the underlay packet by encapsulating the overlay packet based on a layer 3 virtual network, such as VXLAN or GENEVE. The resulting underlay packet may include an added underlay header comprising a backbone MAC source address (BMAC-SA) of the edge node receiving the overlay IP multicast packet, a backbone destination MAC address (BMAC-DA), a backbone source IP address (BIP-SA), a backbone destination IP address (BIP-DA), a backbone virtual local area network value (BVLAN) of the underlay network, and a virtual network identifier (VNI) value of the underlay network. In some aspects, the VNI value may be an identifier corresponding to the layer 3 encapsulation technology in place. For example, the VNI may reflect a VXLAN network identifier. The term VNI may also be referred to as a service identifier or another comparable term understood by those skilled in the art.

In some aspects, the multi-area SPBX underlay network may be split into various sub-network areas known as IP subnets. Subnets may contain a pre-defined grouping of network nodes and devices. Such nodes and devices are uniquely identified and grouped based on an IP address assigned to the underlay IP subnet. Therefore, the network nodes and devices within a particular underlay subnet have similar system IP addresses. The network nodes may also have distinct system identification (ID) values. In some aspects, a system ID value of a network node may correspond to a BMAC value of the same network node. Furthermore, each underlay IP subnet in the multi-area SPBX network may have a corresponding link-state database (LSDB) instance in the ISIS-configured control plane. An LSDB may log and configure the forwarding decisions among the network nodes in a particular IP subnet. Therefore, in some aspects, network nodes within a particular first IP subnet, based on a LSDB of the first IP subnet, may know whether the BIP-DA corresponds to a network node inside or outside the first IP subnet. According to some aspects, the underlay IP subnets within the multi-area SPBX network may be grouped together by summarization. Summarization may include summarizing IP subnet addresses into a shorter prefix and advertising the resulting area—including the network nodes and services contained therein—as a single entity. Therefore, the SPBX network can enable a mesh-centric configuration of areas. This type of configuration allows for more flexible area designs without placing the stringent restrictions on inter-area routers found in many contemporary network solutions. Due to these characteristics, the multi-area SPBX network increases network scalability and avoids the computational and performance constraints of contemporary network topologies.

According to some aspects, the network nodes within the multi-area SPBX network may communicate with each other via a Network-to-Network-Interface (NNI). The NNI may be defined as an ISIS adjacency between network nodes. Moreover, an NNI may carry ISIS control protocol packets and underlay data traffic originating from an overlay IP multicast stream.

In some aspects, the network nodes may also communicate with external devices, such as a host device, via a user-to-network interface (UNI). UNIs may be defined as end-point devices that serve as access interfaces to the multi-area SPBX network. An edge node in the multi-area SPBX network may utilize a UNI to receive data traffic originating from a host device initializing an overlay IP multicast stream. Further, an end node in the multi-are SPBX network may utilize a UNI to forward data traffic originating from an overlay IP multicast stream to a receiving device.

In some aspects, the multi-area SPBX network may contain an inter-area router residing between neighboring underlay IP subnets. For example, the inter-area router may be a router connecting multiple network nodes in different IP subnet areas by routing traffic from one area to another. As such, the inter-area router may have access to the LSDBs in the ISIS-configured control plane for the areas which it borders. Additionally, the inter-area router may utilize at least two NNIs—one for each area it neighbors—to communicate with the network nodes in the areas which it borders.

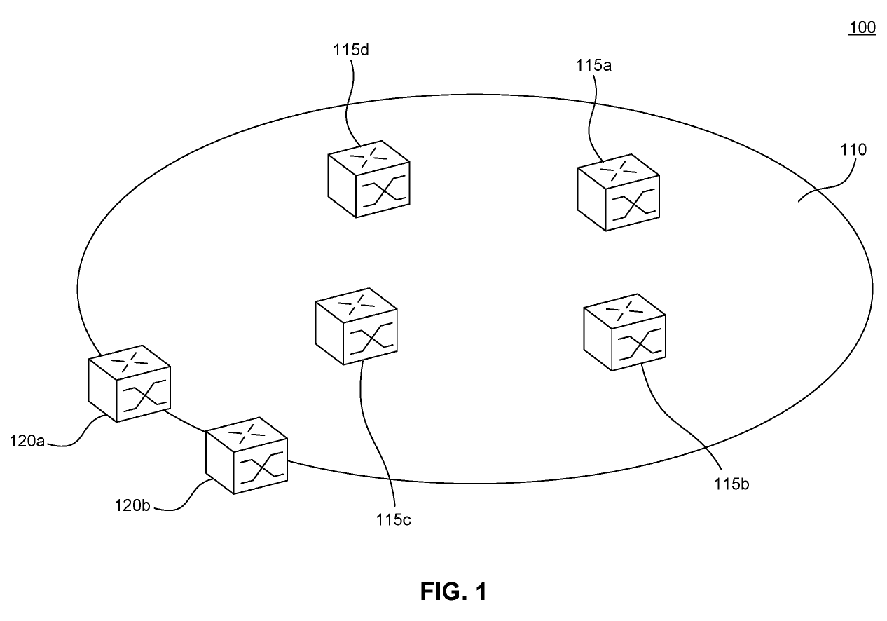

FIG. 1 illustrates a block diagram of an exemplary single area network environment 100, according to some aspects. The single area network environment 100 may be used in other contexts, as will be recognized by a person having ordinary skill in the art(s) reading this disclosure.

In some aspects, the single area network environment 100 may use a control plane configured with an ISIS protocol. As such, all network nodes 115a – 115d (collectively referred to as network node 115 or network nodes 115) and inter-area routers 120a – 120b (collectively referred to as inter-area router 120 or inter-area routers 120) may have a complete copy of an LSDB that defines the topology, services, network nodes 115, and inter-area routers 120 in the single area network environment 100. This allows for the network nodes 115 to have an identical view of the single area network environment 100 and compute the shortest forwarding paths in a consistent manner. The size of the LSDB has a direct impact on the resource requirement for all network nodes 115 (e.g., RAM, CPU power, ASIC capabilities, etc.). As a result, the size of the LSDB may define the upper and lower limits of the single area network environment 100 size and structure. In some aspects, the size and structure of the single area network environment 100 may define the total number of network nodes 115 and available network services (e.g., layer 2 services, layer 3 services, IP multicast services, etc.).

In some aspects, the single area network environment 100 may contain area 110. Area 110 may contain a set of network nodes 115, labeled collectively. The total number of network nodes 115 may be static or dynamic. Network nodes 115 may communicate and transmit data traffic amongst each other via an NNI. Network nodes 115 may be configured with an LSDB in the ISIS control plane that reflects the topology of area 110 and defines the forwarding decisions of the network devices of area 110. For example, network nodes 115 may share ISIS adjacencies that allow ISIS control packets and backbone IP traffic—such as VXLAN encapsulated overlay IP multicast traffic—to be transmitted amongst each other. In some aspects, network nodes 115 may contemporaneously synchronize the LSDB based on receiving and forwarding data packets. Additionally, network nodes 115 may communicate with devices outside of area 110 via a UNI.

In some aspects, area 110 also has inter-area routers 120, labeled collectively. Inter-area routers 120a and 120b may communicate with the network nodes 115. For example, inter-area router 120a may receive data packets from network nodes 115c via a NNI. In some aspects, inter-area routers 120 may also communicate and forward data traffic with network nodes and devices residing outside of area 110. The inter-area routers 120 may route packets to external network nodes and devices via an NNI.

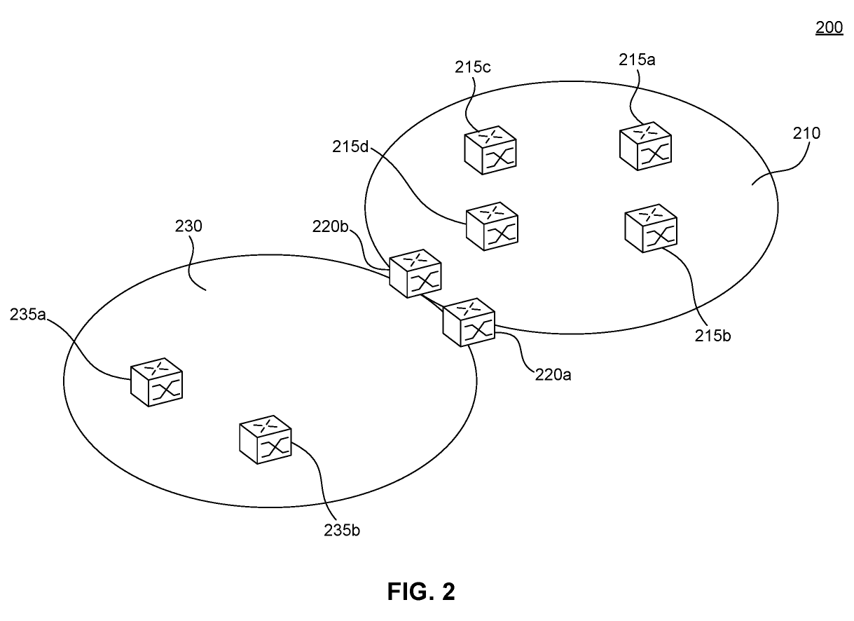

FIG. 2 illustrates a block diagram of an exemplary multi-area network environment 200, according to some aspects. Multi-area network environment 200 is exemplary. Multi-area network environment 200 will be used throughout this disclosure to illustrate the features of this disclosure. Multi-area network environment 200 may be used in other contexts, as will be recognized by a person having ordinary skill in the art(s) reading this disclosure.

In some aspects, multi-area network environment 200 may incorporate the functional characteristics of single area network environment 100, described in FIG. 1, combined with the addition of one or more network areas (also referred to herein as areas). For example, in some aspects, multi-area network environment 200 may contain area 210 and area 230. The aspects of multi-area network environment 200 are not intended to be limited to area 210 and area 230. Multi-area network environment 200 may contain several network segments greater than two, as will be recognized by one skilled in the art(s).

In some aspects, multi-area network environment 200 contains area 210 and area 230. Area 210, similar to area 110 described in FIG. 1, contains a first set of network nodes 215, labeled collectively. Network nodes 215 may communicate and forward data traffic amongst themselves in area 210 via an NNI. Network nodes 215 may contain a first ISIS LSDB instance that reflects the topology of area 210 and defines forwarding decisions among the network nodes 215 of area 210. Furthermore, network nodes 215 may share ISIS adjacencies with each other that allow ISIS control packets and backbone IP traffic—such as underlay encapsulated overlay IP multicast traffic—to be transmitted over area 210. The LSDB of area 210 may be synchronized contemporaneously based on an event affecting the multi-area network environment 200 topology such as, but not limited to, the introduction of a new network device or node, the reception of a unicast or IP multicast stream, the intra-area reception and transmission of data packets, or a combination thereof. In some aspects, network nodes 215 may communicate with an external device outside of multi-area network environment 200 via a UNI. For example, network node 215a may receive an overlay data packet of an IP multicast stream originating from a host device outside of area 210.

In some aspects, multi-area network environment 200 contains a second area 230. Area 230 may contain a second set of network nodes 235, labeled collectively. For example, network nodes 235a and 235b may bridge or route underlay packets between each other via an NNI. Similar to network nodes 215 in area 210, network nodes 235 may receive and forward data traffic with devices external to multi-area network 200 via a UNI. Network nodes 235 may contain a second ISIS LSDB instance that reflects the topology of area 230 and defines forwarding decisions among the network nodes 235 of area 230. Furthermore, network nodes 235 may share ISIS adjacencies with each other that allow ISIS control packets and backbone IP traffic—such as underlay encapsulated overlay IP multicast traffic—to be transmitted across area 230. The LSDB of area 230 may be synchronized contemporaneously based on an event affecting the multi-area network environment 200 topology such as, but not limited to, the introduction of a new network device or node, the reception of a unicast or IP multicast stream, the intra-area reception and transmission of data packets, or a combination thereof.

In some aspects, multi-area network environment 200 may contain inter-area routers 220, labeled collectively. For example, inter-area router 220a and inter-area router 220b may route underlay data traffic from area 210 into area 230 and from area 230 into area 210. Inter-area routers 220 may facilitate network communications from the network nodes 215 in area 210 and network nodes 235 in area 230 via an NNI. In some aspects, inter-area routers 220 may receive underlay packets from network nodes 215 in area 210 and network nodes 235 in area 230 via bridged or routed protocols. Inter-area routers 220 may route underlay packets between area 210 and area 230. In some aspects, inter-area routers 220 may contain the LSDBs in the ISIS-configured control plane for each neighboring area. For example, inter-area routers 220 may contain the LSDBs of both area 210 and area 230.

In some aspects, network nodes 215 and network nodes 235 may perform intra-area forwarding operations by bridging underlay traffic. Bridging may refer to the process of forwarding an underlay packet to an underlay area egress point without altering the contents of the underlay packet header. For example, network node 215a may bridge an underlay packet to network node 215b by looking up the BMAC-DA and backbone VLAN (BVLAN) value of the underlay packet header in the layer 3 forwarding table of area 210 and forwarding the underlay packet according to the ISIS shortest path tree calculation.

In some aspects, network nodes 215 and network nodes 235 may perform intra-area multicast routing of underlay traffic. Multicast routing may refer to the process of forwarding an underlay packet to another component of multi-area network 200 after altering the contents of the underlay packet header. For example, network node 215a may route an underlay packet to network node 215b by forwarding the underlay packet commensurate with a Source, Group, VLAN value corresponding to the IP multicast stream. To route underlay multicast traffic, network nodes 215 and network nodes 235 alter the BMAC-SA of the underlay packet header to correspond to the MAC address of the network node performing the multicast routing operation. For example, network node 215a may change the BMAC-SA of the underlay packet header to be its own MAC address in order to route the packet to network node 215b.

In some aspects, inter-area routers 220 may perform inter-area forwarding operations by routing the underlay packets from area 210 into area 230. For example, similar to the operations described above, inter-area router 220a may route an underlay packet from area 210 into area 230 by changing the BMAC-SA of the underlay packet header to correspond to the MAC address of inter-area router 220a prior to forwarding the packet. Additionally, inter-area routers 220 may de-increment a time-to-live (TTL) value associated with the underlay packet by one as the packet is routed from area 210 into are 230.

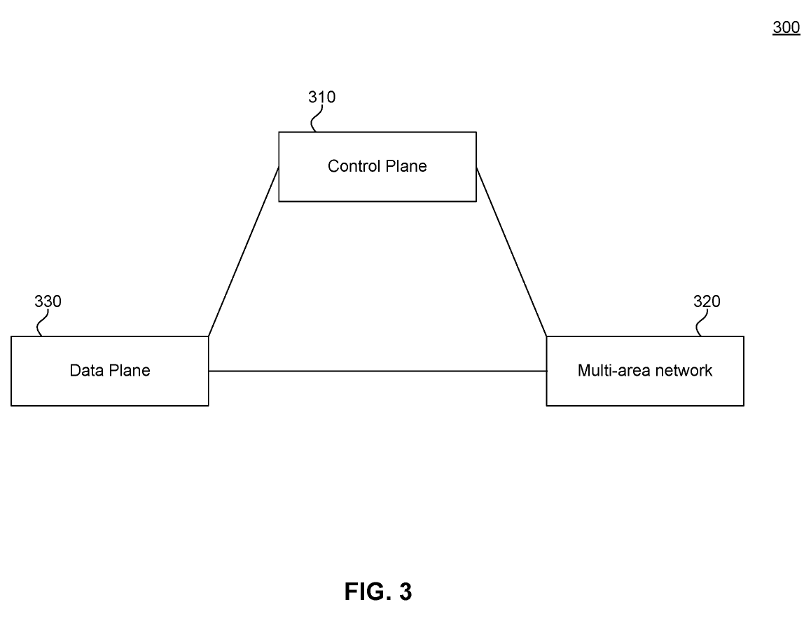

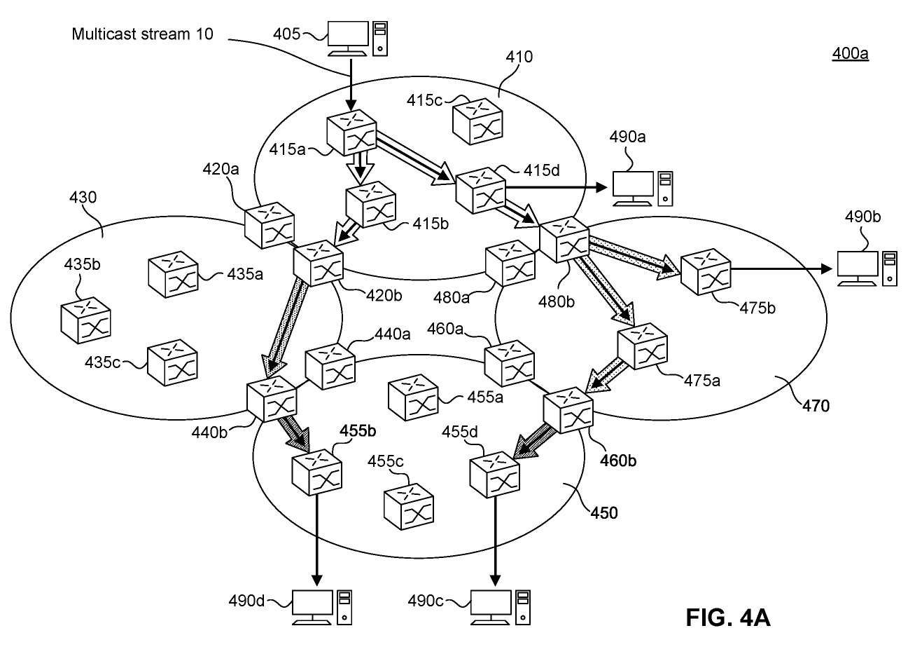

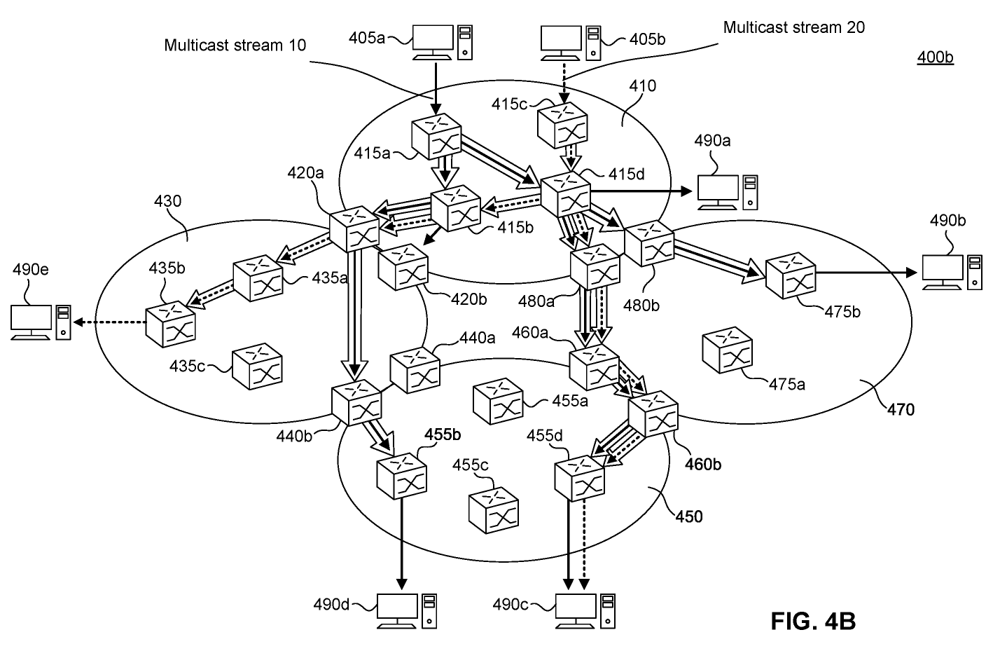

FIG. 3 illustrates a block diagram for a control plane system 300 implemented in a multi-area network, according to some aspects. The control plane system 300 has a control plane 310 that connects to a data plane 330 and a multi-area network 320. The multi-area network 320 may reflect the multi-area network aspects described herein, such as the multi-area network environment 200 described in FIG. 2 and/or the IP multicast multi-area network environments 400a and 400b described in FIGS. 4A and 4B, respectively. The connection between multi-area network 320, data plane 330, and control plane 310 can be over a fabric technology. In some aspects, the fabric technology allows for communication or connection between entities with an established IP and MAC Address. In some aspects, the fabric technology allows for communication or connection between entities without an IP connection.

Data plane 330 can be data processing elements, such as some or all of a computer system (e.g., computer system 1000). In some aspects, data plane 330 can store state information about the multi-area network 320, its topology, services available, IP-based virtualization data, and MAC information. In some aspects, the data plane 330 may be based on a layer 3 communication protocol, such as IPv4 or IPv6. Data plane 330 may process network operations among the multi-area network 320 by supporting overlay traffic encapsulation processes. In some aspects, the encapsulation processes may include VXLAN encapsulation using IPv4 or IPv6 or Generic Network Virtualization Encapsulation (GENEVE).

In some aspects, the control plane 310 may be a single instance of an ISIS protocol. The control plane 310 may receive information from data plane 330 and send out update information to multi-area network 320. In some aspects, the packets analyzed or processed in the data plane 330 can be used to program tables of information for later use and send the information to the control plane 310. For example, the tables of information may include routing tables and LSDBs. The network elements within the multi-area network 320 may utilize the control plane 310 to form ISIS adjacencies with neighboring network elements. The control plane 310 may compute the shortest path from one network element to another network element in the multi-area network 310. For example, the control plane 310 may compute the shortest forwarding path among network elements by generating a shortest-path forwarding (SPF) tree corresponding to an overlay IP multicast stream.

In some aspects, control plane 310 can be configured to send messages to data plane 330 or multi-area network 320. In some aspects, the messages can be sent by certain protocols, such as inter-process communication (IPC) protocols or remote procedure call (RPC) protocols.

FIG. 4A illustrates a block diagram of an IP multicast multi-area network environment 400a according to some aspects. Like the multi-area network environment 200 described in FIG. 2, the IP multicast multi-area network environment 400a may be segmented into multiple areas such as underlay IP subnets. In some aspects, the IP multicast multi-area network environment 400a may be segmented into a first area 410, a second area 430, a third area 450, and a fourth area 470. Area 410 may contain a first set of network nodes 415 (labeled collectively), area 430 may contain a second set of network nodes 435 (labeled collectively), area 450 may contain a third set of network nodes 455 (labeled collectively), and area 470 may contain a fourth set of network nodes 475 (labeled collectively). IP multicast multi-area network environment 400a will be described with reference to the elements enumerated in FIG. 3; however, environment 400a is not limited to these example aspects.

In some aspects, the areas of environment 400a are assigned their own range of underlay subnet IP addresses. For example, area 410 may have an underlay subnet IP address of 10.1.0.0/24. For example, area 430 may have an underlay subnet IP address of 10.2.0.0/24. For example, area 450 may have an underlay subnet IP address of 10.3.0.0/24. For example, area 470 may have an underlay subnet IP address of 10.4.0.0/24. Network nodes 415 may be assigned unique system IP addresses commensurate with the underlay subnet IP address of area 410 with a distinct host address value. For example, network node 415a may be assigned a system IP address of 10.1.0.1/24, network node 415b may be assigned a system IP address 10.1.0.2/24, network node 415c may be assigned a system IP address 10.1.0.3/24, and network node 415d may be assigned a system IP address 10.1.0.4/24. The network nodes of environment 400a may also be given a system ID representative of the network nodes’ respective MAC addresses.

In some aspects, network nodes 415, 435, 455, and 475 in environment 400a may have similar functional characteristics of network nodes 215 and 235 in multi-area network environment 200, as described in FIG. 2. In some aspects, the access port of an edge node (e.g., network node 415a) may detect multicast stream 10 introduced into area 410. Network node 415a may announce multicast stream 10 into a local LSDB of area 410 on the ISIS-configured control plane 310. Multicast stream 10 may be announced into the LSDB of area 410 via a Type-Length-Value (TLV) encoding scheme. In some aspects, the TLV data object may include an overlay source IP address corresponding to host device 405, an overlay IP multicast group value, an overlay scope VNI value based on a layer 2 or layer 3 instance, and a per-IP-multicast stream data VNI assigned from a per network node reserved range. The per-IP-multicast stream data VNI may be assigned via a hashing algorithm or a comparable unique identifier generator algorithm. In some aspects, the IP multicast group value of the multicast stream 10 may be organized using an Internet Group Management Protocol (IGMP), a multicast listener discovery (MLD) protocol, or a combination thereof. Therefore, network nodes 415, 435, 455, and 475 in environment 400a may manage the group membership of the multicast stream 10 on the access ports of the edge node receiving the stream (e.g., network node 415a).

In some aspects, multicast stream 10 originating from host device 405 may be an overlay IP multicast stream containing an overlay packet. The contents of the overlay packet may correspond to the data transmitted by multicast stream 10, such as CMAC-SA, CMAC-DA, and CVLAN values from a payload Ethernet frame. Furthermore, the overlay packet of multicast stream 10 may specify a group of receiving devices 490, labeled collectively. The receiving devices 490 may correspond to an end node either inside or outside of the originating network area. For example, an end node in environment 400a may be one of network nodes 415d, 455b, 455d, or 475b.

In some aspects, any network device in environment 400a may receive the multicast stream 10. For example, network node 415a may receive an overlay packet from multicast stream 10 originating from host device 405. In some aspects, network node 415a encapsulates the overlay packet into an underlay packet to be forwarded across the underlay mesh network environment 400a. The encapsulation may be based on a layer 3 virtual network, such as VXLAN or GENEVE. The resulting underlay header may comprise the BMAC-SA corresponding to network node 415a, the BIP-SA corresponding to network node 415a, a virtual network identifier (VNI) derived by network node 415a, a BMAC-DA derived from a nickname corresponding to network node 415a and a VNI value of multicast stream 10, a BIP-DA derived from a VNI value of multicast stream 10, and a BVLAN value.

In some aspects, environment 400a may be configured to determine a BVLAN value for area 410 by a hashing algorithm or comparable unique identifier generator function. An edge node, such as network node 415a, may assign the BVLAN value to the underlay packet once the overlay packet of multicast stream 10 is received and encapsulated.

In some aspects, the VNI value is derived from a pre-defined range of VNI values in environment 400a. For example, the predefined range of bit values may range from 16,000,001 to 16,299,999. A receiving edge node, such as network node 415a, may allocate one VNI value per IP multicast stream introduced to environment 400a. Another edge node in network environment 400a, such as network node 415c, may also derive the same or a different VNI value from the pre-defined range of VNI values corresponding to a subsequent multicast stream. For example, network node 415a may derive a VNI value of 16,000,001 corresponding to multicast stream 10. Network node 415c may also derive a VNI value of 16,000,001 for a subsequent multicast stream it receives.

In some aspects, the BIP-DA of the underlay packet may be derived by the edge node, such as network node 415, based on the VNI value allocated to the overlay IP multicast stream, such as multicast stream 10.

In some aspects, the BMAC-DA may be derived by the edge node, such as network node 415a, based on a nickname and VNI value. A nickname may correspond to a predefined number of least significant bits of an IP address of the edge node. In some aspects, the predefined number of least significant bits may be 20 bits. The nicknames of all of the network nodes in environment 400b may be grouped based on an IP subnet address reflecting an area. In some aspects, the BMAC-DA may be derived based on the multicast BIP-DA.

In some aspects, network node 415a may create a shortest-path forwarding (SPF) tree based on the LSDB in the ISIS-configured control plane 310. For example, network node 415a may utilize the LSDB instance in the control plane 310 for area 410 to calculate a shortest forwarding path to the receiving devices 490. The SPF tree may utilize a series of forwarding nodes among areas 410, 430, 450, and 470 to forward the underlay packet to the receiving devices 490.

In some aspects, the SPF tree corresponding to multicast stream 10 may be associated with a nickname and VNI value. In some alternative aspects, the SPF tree may be associated with an underlay Source Group Virtual Local Area Network (SGV) value corresponding to an edge node (e.g., network node 415a). The SGV value may refer to a tuple comprising a BIP-SA of the edge node, an IP multicast group IP address reflecting a VNI value derived by the edge node, and a virtual local area network (VLAN) value of the edge node. In some aspects, environment 400a may be configured to assign a nickname and VNI value or SGV value to the SPF tree based on a total number of network nodes. For example, an edge node may assign the SPF tree a nickname and VNI value if the total number of network nodes in environment 400a is less than 1 million. Alternatively, the edge node may assign the SPF tree an SGV value if the total number of network nodes in environment 400a.

In some aspects, environment 400a may contain a set of inter-area routers that border the segmented underlay areas of the network environment 400a (e.g., inter-area routers 420, 440, 460, and 480 (labeled collectively)). The inter-area routers of environment 400a may refer to a collection of routers. For example, inter-area router 420b may reside between area 410 and area 430. In some aspects, an inter-area router may reside between more than two areas. For example, an inter-area router may reside between three or more of area 410, area 430, area 450, and area 470. Furthermore, inter-area router 420b may receive an underlay packet from network node 415b via an NNI and route the packet to one of the network nodes 435 in area 430. Based on the reception of the underlay packet, inter-area router 420b may route the underlay packet by changing the BMAC-SA of the underlay packet to be its own system ID. The system ID of inter-area router 420b may reflect the MAC address of inter-area router 420b. The other inter-area routers of environment 400a may be configured to perform functions identical to those of inter-area router 420b.

In some aspects, an inter-area router in environment 400a may understand the network topology of environment 400a, such as the segmented areas within a multi-area network 320. For example, inter-area router 420a may advertise itself, via the LSDB of area 410 in an ISIS-configured control plane 310, as a viable forwarding route into area 430. Furthermore, inter-area router 420a may determine a shortest forwarding path to forward underlay traffic into area 450 by querying the LSDB of area 430 in the ISIS-configured control plane 310. The shortest forwarding path determined by inter-area router 420a may correspond to the SPF tree of multicast stream 10.

In some aspects, the end nodes of environment 400a (e.g., network nodes 415d, 455b, 455d, and 475b) de-encapsulate the overlay packet within the underlay packet. The end nodes may de-encapsulate the overlay packet by removing the underlay header added to the overlay packet. For example, network node 415d may remove the underlay header within the underlay packet. Additionally, network node 415d may perform a layer 3 table lookup with an overlay SGV value of multicast stream 10. The overlay SGV value may be a tuple comprising overlay multicast stream fields such as an overlay source IP address of the host device 405a, a destination IP address corresponding to the multicast group of multicast stream 10, and an identifier based on virtual routing and forwarding. The identifier based on virtual routing and forwarding may reflect a layer 3 virtual network to which host device 405a and the receiving device 490b belong to. The layer 3 lookup operation may be performed on an overlay IP multicast table. The overlay IP multicast table may be populated by the help of a multicast membership protocol, described in further detail below. A matching entry will point to a UNI that specifies how the de-encapsulated overlay packet may be forwarded to receiving device 490a. Therefore, network node 415d may only forward the overlay packet and the contents therein to receiving device 490a.

In some aspects, an inter-area router in environment 400a may be able to calculate a distance metric between intra- and inter-area network nodes. For example, inter-area router 420a may calculate a distance metric for each network node 415 in area 410 to network nodes 435 in area 430 and/or to network nodes 455 in area 450. In some aspects, the distance metric may be representative of a path cost. A path cost may indicate a network distance to forward underlay traffic among the various network nodes in environment 400a. In some aspects, the lowest distance metric reflects the shortest-path bridged. In some aspects, the distance metric may also be defined by an SPF tree corresponding to an overlay IP multicast stream. For example, the SPF tree relating to multicast stream 10 may illustrate distance metrics from its root node, network node 415a, to the end nodes, such as network node 455b, connected to receiving devices 490. In some aspects, an inter-area router in environment 400a may input its calculated distance metrics into an LSDB of an ISIS-configured control plane 310. For example, inter-area router 420a may input the distance metrics corresponding to network nodes 415 into the LSDB of area 410.

In some aspects, an inter-area router in environment 400amay determine a forwarding decision to a forwarding node based on the underlay SGV corresponding to multicast stream 10. For example, if the underlay packet was to be routed by inter-area router 420a to a network node 435 in area 430 from area 410, inter-area router may route the underlay packet to a network node 435 based on a layer 3 table lookup with the underlay SGV value. For example, network node 420a may determine that the next forwarding node is network node 435a based on a layer 3 table lookup of the underlay SGV value corresponding to multicast stream 10.

FIG. 4B illustrates a block diagram of multiple overlay IP multicast streams within multi-area network environment 400b according to some aspects. In some aspects, environment 400b retains the same multi-area network elements and their corresponding functional capabilities as enumerated in environment 400a of FIG. 4A. A second multicast stream 20 from host device 405b is introduced in environment 400b to further illustrate the features of this disclosure. Additionally, environment 400b will be described with reference to the elements enumerated in FIG. 3; however, environment 400b is not limited to these example aspects.

In some aspects, environment 400b may reflect an instance in which a plurality of multicast streams introduced into a multi-area network 320. For example, area 410 in environment 400b may receive two distinct overlay IP multicast streams (e.g., multicast stream 10 and multicast stream 20) from two different host devices (e.g., host devices 405a and 405b). Similar to the aspects described in FIG. 4A, an overlay IP multicast stream may be received by any of the network devices in environment 400b. For example, network nodes 415a and 415c may receive the overlay packet transmissions from multicast stream 10 and multicast stream 20, respectively.

In some aspects, each time an edge node (e.g., network nodes 415a and 415c) receives a distinct overlay IP multicast stream (e.g., multicast streams 10 and 20), the edge node creates an SPF tree for each distinct multicast stream. For example, network node 415a creates a first SPF tree upon receiving multicast stream 10 and network node 415c creates a second SPF tree upon receiving multicast stream 20. The SPF trees corresponding to multicast streams 10 and 20 may each be associated with a nickname value corresponding to the ingress edge node receiving the stream—such as network node 415a and network node 415c, respectively—and VNI values derived by the aforementioned edge nodes or unique SGV values depending on how environment 400b is configured, as described in FIG. 4A.

In some aspects, the inter-area routers of environment 400b (e.g., inter-area routers 420, 440, 460, and 480 (labeled collectively)) have the same functional capabilities as described in FIG. 4A. The inter-area routers of environment 400b may contain an LSDB instance in the ISIS-configured control plane 310 for the areas in which they border. For example, inter-area router 420a may contain an LSDB instance corresponding to both areas 410 and 430. Each time a new multicast stream is introduced into environment 400b, inter-area router 420a may announce the multicast stream into its LSDB instances. For example, inter-area router 420a may announce multicast stream 10 into the LSDB of area 430. Inter-area router 420a may announce multicast stream 10 via a TLV encoding scheme. The TLV data object may include the overlay SGV value described in FIG. 4A, such as an overlay source IP address corresponding to host device 405a, an overlay IP multicast group value, an overlay scope VNI value based on a layer 2 or layer 3 instance, and a per-IP-multicast stream data VNI assigned from a per network node reserved range. Furthermore, inter-area router 420a may announce multicast stream 20 into the LSDB of area 430 via a second TLV data object. Additionally, inter-area router 420a may advertise to the LSDB instance of area 410 that it may forward underlay multicast packets into the area 430. In some aspects, inter-area router 420a may perform data traffic operations through an implemented control plane environment 300 and the elements contained therein.

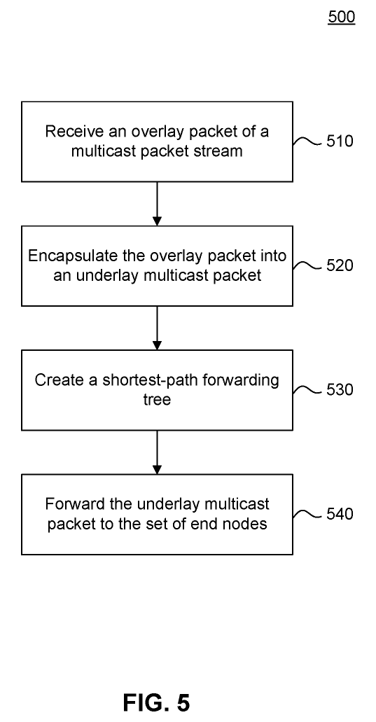

FIG. 5 is a flow chart illustrating method 500 for forwarding an overlay IP multicast stream over a multi-area network, according to some aspects. Method 500 can be employed in aspects of the multi-area networks described herein, such as multi-area network environments 400a and 400b. Method 500 will be described with reference to the elements enumerated in FIGS. 3, 4A, and 4B; however, method 500 is not limited to these example aspects.

In some aspects, method 500 can be implemented to forward multicast streams as described in multi-area network environments 400a and 400b. In some aspects, a multi-area network environment, such as environment 400a, may contain a first set of network nodes inside a first area and a second set of network nodes inside a second area, such as areas 410 and 430, respectively. In some aspects of method 500, the environment 400a may contain a third set of network nodes inside a third area outside of the first and second areas, such as area 450, and a fourth set of network nodes in a fourth area outside of the first, second, and third areas, such as area 470.

At 510, an overlay packet of a multicast stream is received. For example, an overlay packet of a multicast stream, such as multicast stream 10, is received by an edge node, such as network node 415a in area 410. Network node 415a will be used as an exemplary edge node to illustrate the features of method 500. However, method 500 is not limited to this exemplary aspect.

The overlay packet may be designated to be forwarded to a set of end nodes corresponding to the receiving devices 490, such as network node 455b and receiving device 490d. Network node 455b and receiving device 490d will be used as an exemplary end node and receiving device, respectively, to illustrate the features of method 500. However, method 500 is not limited to these exemplary aspects.

In some aspects, the overlay packet may reflect a payload Ethernet frame comprising a CMAC-SA corresponding to a host device 405, a CMAC-DA derived from an IP multicast group corresponding to multicast stream 10, a CVLAN value, an overlay source IP address of host device 405, and an overlay destination multicast IP address corresponding to multicast stream 10.

At 520, an overlay packet is encapsulated into an underlay multicast packet. For example, an overlay packet from multicast stream 10 is encapsulated into an underlay packet by network node 415a. In some aspects, the underlay packet may be encapsulated based on a layer 3 virtual network. For example, the layer 3 virtual network may be based on VXLAN, GENEVE, or a comparable layer 3 network virtualization technology. In some aspects, the overlay packet may be encapsulated into an underlay packet by adding an underlay header to the overlay packet. In some aspects, adding the underlay packet may mean prepending the underlay header to the overlay packet. The underlay header may include a source MAC address of network node 415a, a source IP address of network node 415a, a destination MAC address of multicast stream 10, a destination IP address of multicast stream 10, a BVLAN assigned to multicast stream 10 by network node 415a, and a VNI value derived by network node 415a. In some aspects, the source MAC address may be a BMAC-SA of network node 415a. In some aspects, the source IP address of network node 415a maybe a BIP-SA of network node 415a. In some aspects, the destination IP address of network node 455b may be a multicast backbone IP address (MBIP-DA) from the VNI value derived by the network node 415a. In some aspects, the destination MAC address of multicast stream 10 may be a BMAC-DA reflecting the nickname and VNI value derived by network node 415a. Additionally, the destination MAC address of network node 455b may be derived from a multicast backbone IP address (MBIP-DA) of multicast stream 10. To derive a respective VNI value, network node 415a may use a hashing algorithm to assign multicast stream 10 an available VNI value from a range of VNI values corresponding to network node 415a.

At 530, a SPF tree is created. For example, an SPF tree is created by network node 415a, according to some aspects. The SPF tree may specify a root node corresponding to network node 415a, a set of forwarding nodes in environment 400a, and a set of end nodes connected to a set of receiving devices 490, including network node 455b and receiving device 490d, respectively. The SPF tree may be created by performing Dijsktra’s algorithm, reverse path forwarding, or a combination thereof.

In some aspects, network node 415a may assign a nickname and a VNI value derived by network node 415a to the SPF tree. The nickname may be linked to a predefined number of least significant bits of an IP address of network node 415a. In some aspects, the predefined number of least significant bits may be 20 bits. In some aspects, network node 415a, using the set of forwarding nodes of the SPF tree, may bridge the underlay packet across the multi-area network environment 400a based on the nickname assigned to the SPF tree. For example, network node 415a may bridge an underlay packet to network node 415b based on querying a layer 3 multicast forwarding table of area 410 for a shortest-path bridged of the BMAC-DA and BVLAN of the underlay packet over environment 400a. In some aspects, the layer 3 multicast forwarding table of area 410 may be programmed by an LSDB of area 410. The bridging operations performed by network node 415a and the forwarding nodes may reflect the generated SPF tree for multicast stream 10.

In some aspects, network node 415a may assign an underlay Source, Group, VLAN (SGV) value corresponding to multicast stream 10. The underlay SGV value may be represented by a tuple comprising a source IP address of network node 415a, a group IP address derived from a VNI of network node 415a, and a VLAN value derived by network node 415a. In some aspects, network node 415a, using the set of forwarding nodes of the SPF tree, may route the underlay packet over the multi-area network environment 400a based on the underlay SGV value assigned to the SPF tree. For example, network node 415a may route the underlay packet to network node 415b based on searching the layer 3 multicast forwarding table of area 410 for a table entry containing the BIP-SA, BIP-DA, and BVLAN values equaling the underlay SGV value tuple. In some aspects, the layer 3 multicast forwarding table of area 410 may be programmed by an LSDB of area 410. The resulting table entry lookup may indicate a shortest routing path over environment 400a. The routing operations performed by network node 415a may reflect the generated SPF tree for multicast stream 10.

At 540, the underlay multicast packet is forwarded to the set of end nodes. For example, network node 415a, and using the set of forwarding nodes of the SPF tree, forwards the underlay packet to the set of end nodes, such as network node 455b, according to some aspects.

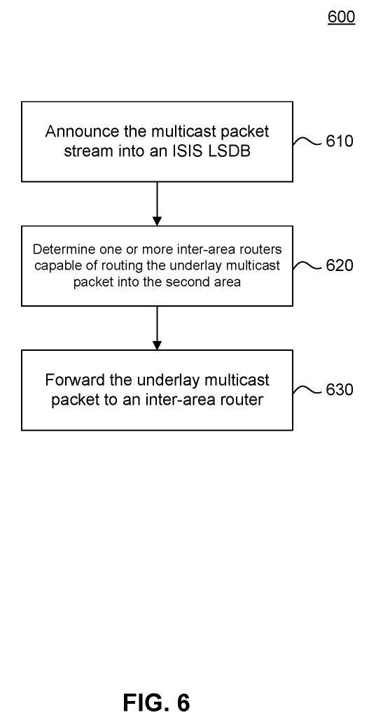

FIG. 6 is a flow chart illustrating method 600 for forwarding an underlay packet to an inter-area router using an Intermediate System to Intermediate System (ISIS) link-state database, according to some aspects. Method 600 can be employed in aspects of the multi-area networks described herein, such as multi-area networks environments 400a and 400b. Method 600 will be described with reference to the elements enumerated in FIGS. 3, 4A, and 4B; however, method 600 is not limited to these example aspects.

In some aspects, method 600 can be implemented to forward multicast streams as described in multi-area network environments 400a and 400b. For example, method 600 may utilize an edge node within a first area and inter-area router between the first area and a second area. Network node 415a in area 410 and inter-area router 420a between areas 410 and 420 will be used as an exemplary edge and inter-area router, respectively, to illustrate the features of method 600. However, method 600 is not limited to these exemplary aspects.

At 610, a multicast stream is announced. For example, network node 415a announces multicast stream 10 into an LSDB instance of the area 410, according to some aspects. The LSDB instance may be within an ISIS-configured control plane 310. Network node 415a may announce multicast stream 10 via a TLV encoding scheme into the LSDB of the area 410. For example, network node 415a announce multicast stream 10 based on an overlay SGV value. In this case, the TLV data object may include an overlay source IP address corresponding to host device 405a, an overlay IP multicast group value, an overlay scope VNI value based on a layer 3 instance, and a per-IP-multicast stream data VNI assigned from a per network node reserved range. The per-IP-multicast stream data VNI may be created via a hashing algorithm or a comparable unique identifier generator algorithm. In some aspects, the IP multicast group value of multicast stream 10 may be organized using an Internet Group Management Protocol (IGMP), a multicast listener discovery (MLD) protocol, or a combination thereof. In some aspects, multicast stream 10 may be detected on an access port of network node 415a.

At 620, one or more inter-area routers capable of routing the underlay packet into the second area are determined. For example, network node 415a determines that inter-area router 420a is capable of routing the underlay packet into area 430, according to some aspects. Network node 415a may make this determination by querying the layer 3 multicast forwarding table of area 410. The layer 3 multicast forwarding of area 410 may indicate that the shortest path, in accordance with the SPF tree associated with multicast stream 10, includes inter-area router 420a. In some aspects, a layer 3 multicast forwarding table of an area in environment 400b may be programmed by an LSDB of the ISIS-configured control plane 310.

At 630, the underlay multicast packet is forwarded to the one or more routers inter-area router based on the SPF tree. For example, network node 415a, and using the set of forwarding nodes of the SPF tree, forwards the underlay packet to inter-area router 420a, according to some aspects. Inter-area router 420a may be selected to reflect the SPF tree of multicast stream 10 based on the one or more inter-area routers determined in box 620. Furthermore, inter-area router 420a may be included in the SPF tree of multicast stream 10 based on one or more of network nodes 435 advertising to receive multicast stream 10. In some aspects, the underlay packet may be forwarded by bridging or multicast routing procedures, as described in box 530 of method 500.

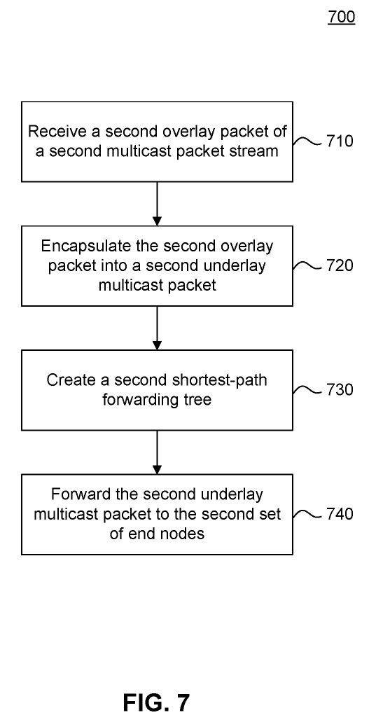

FIG. 7 is a flow chart illustrating method 700 for forwarding a second overlay IP multicast stream across a multi-area network, according to some aspects. Method 700 can be employed in aspects of the multi-area networks described herein, such as multi-area network environment 400b. Method 700 will be described with reference to the elements enumerated in FIGS. 3, 4A, and 4B; however, method 700 is not limited to these example aspects.

In some aspects, method 700 can be implemented to forward multicast streams as described in multi-area network environment 400b. For example, method 700 may utilize an edge node within a first area, inter-area router between the first area and a second area, and a set of end nodes corresponding to a set of receiving devices. As enumerated in environment 400b described in FIG. 4B, network node 415c in area 410, inter-area router 420a between areas 410 and 430, network node 435b, and receiving device 490e will be used as an exemplary edge node, inter-area router, end node, and receiving device, respectively, to illustrate the features of method 700. However, method 700 is not limited to these exemplary aspects.

At 710, a second overlay packet of a second multicast stream is received. For example, network node 415c receives a second overlay packet of a second multicast stream, such as multicast stream 20, according to some aspects. In some aspects, the second overlay packet may reflect a payload Ethernet frame comprising a CMAC-SA corresponding to a host device 405, a CMAC-DA derived from a multicast group corresponding to multicast stream 10, a CVLAN value, an overlay source IP address of host device 405, and an overlay destination multicast IP address corresponding to multicast stream 20. Network node 415c may announce multicast stream 20 via a second TLV data object into the LSDB instance of area 410. The second TLV data object may contain elements equivalent to what was described in box 610 of method 600. In such cases, the TLV data object may reflect an overlay SGV value. In some aspects, a layer 3 multicast forwarding table of an area in environment 400b may be programmed by an ISIS LSDB of control plane 310.

At 720, the second overlay packet is encapsulated into a second underlay multicast packet. For example, network node 415c encapsulates the second overlay packet from multicast stream 20 into a second underlay packet, according to some aspects. The second underlay packet may be encapsulated based on a layer 3 virtual network. For example, the layer 3 virtual network may be based on VXLAN, GENEVE, or a comparable layer 3 network virtualization technology. The layer 3 virtual network described herein may be the same layer 3 virtual network enumerated in box 520 of method 500. In some aspects, the second overlay packet may be encapsulated into a second underlay packet by adding an underlay header to the second overlay packet. In some aspects, adding the underlay header may mean prepending the underlay header to the second overlay packet. The underlay header may include a source MAC address of network node 415c, a source IP address of network node 415c, a destination MAC address of multicast stream 20, a destination IP address multicast stream 20, a BVLAN assigned to multicast stream 20 by network node 415c, and a second VNI value derived by network node 415c. In some aspects, the source MAC address may be a BMAC-SA of network node 415c. In some aspects, the source IP address of network node 415c may be a BIP-SA of network node 415c. In some aspects, the destination IP address may be an MBIP-DA derived from the VNI of the network node 415c. In some aspects, the destination MAC address may be a BMAC-DA derived from the nickname and VNI value corresponding to network node 415c. Additionally, the destination MAC address may be derived from the MBIP-DA of multicast stream 20.

At 730, a second SPF tree is created. For example, network node 415c creates a second SPF tree, according to some aspects. The second SPF tree may specify a second root node corresponding to network node 415c, a second set of forwarding nodes in the multi-area network environment 400b, and a second set of end nodes connected to a second set of receiving devices 490, including network node 435b and receiving device 490e, respectively. The second SPF tree may be created by performing Dijsktra’s algorithm, reverse path forwarding, or a combination thereof.

In some aspects, network node 415c may assign a nickname and a VNI value derived by network node 415c to the second SPF tree. The nickname and VNI values assigned to the second SPF tree may be different than the nickname and VNI values assigned to the SPF tree described in box 530 of method 500. Alternatively, in some aspects, the VNI assigned to the second SPF tree associated multicast stream 20 may be the same VNI than what was assigned to multicast stream 10. For example network node 415c may derive a same VNI similarly derived by network node 415a based on an applied hashing algorithm. The nickname may correspond to a predefined number of least significant bits of the IP address of network node 415c. In some aspects, the predefined number of least significant bits may be 20 bits. In some aspects, network node 415c, using the set of forwarding nodes of the second SPF tree, may bridge the underlay packet over the multi-area network environment 400b based on the nickname assigned to the second SPF tree. For example, network node 415c may bridge an underlay packet to network node 415d based on querying the layer 3 multicast forwarding table of area 410 for a shortest-path bridged of the BMAC-DA and BVLAN of the underlay packet over environment 400b. The bridging operations performed by network node 415c may reflect the generated second SPF tree for multicast stream 20.

In some aspects, network node 415c may assign an underlay SGV value corresponding to multicast stream 20 to the second SPF tree. The underlay SGV value may be represented by a source IP address of network node 415c, a group IP address reflecting a VNI value derived by network node 415c, and a VLAN value derived by network node 415c. In some aspects, network node 415c, using the second set of forwarding nodes of the second SPF tree, may route the underlay packet across multi-area network environment 400b based on the underlay SGV value assigned to the second SPF tree. For example, network node 415c may route the underlay packet to network node 415d based on searching the layer 3 forwarding table of area 410 for a table entry containing the BIP-SA. BIP-DA, and BVLAN values equaling the underlay SGV value array. The resulting table entry lookup may indicate a shortest multicast routing path over environment 400b. The routing operations performed by network node 415c may reflect the generated second SPF tree for multicast stream 20.

At 740, the second underlay multicast packet is forwarded to the second set of end nodes. For example, network node 415c, using the second set of forwarding nodes of the second SPF tree, forwards the second underlay packet to the second set of end nodes, such as network node 435b, according to some aspects.

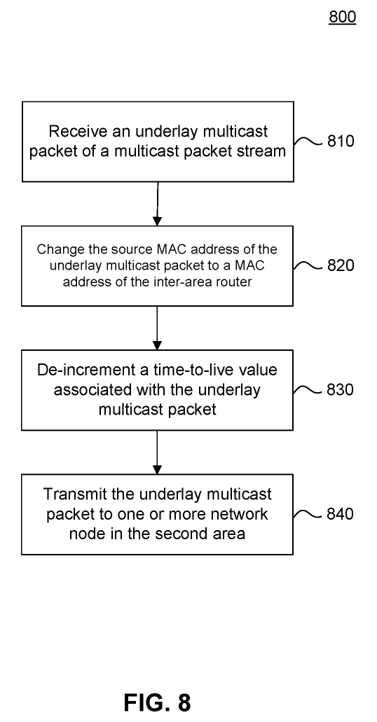

FIG. 8 is a flow chart illustrating method 800 for forwarding an underlay packet of a multicast stream from a first area of network nodes into a second area of network nodes outside of the first area, according to some aspects. Method 800 can be employed in aspects of the multi-area networks described herein, such as multi-area networks environments 400a and 400b. Method 800 will be described with reference to the elements enumerated in FIGS. 4A and 4B; however, method 800 is not limited to these example aspects.

In some aspects, method 800 can be implemented to forward multicast stream traffic across the multiple areas described in multi-area network environments 400a and 400b. For example, method 800 may utilize an inter-area router between a first area and a second area, a set of network nodes in a first area, a set of network nodes in a second area, and an end node in a set of end nodes in the multi-area network fabric. As enumerated in environment 400b described in FIG. 4B, inter-area router 420a between areas 410 and 430, network nodes 415 of area 410, network nodes 435 of area 430, and network node 455b will be used as an exemplary inter-area router, set of network nodes in a first area, set of network nodes in a second area, and end node, respectively, to illustrate the features of method 800. However, method 800 is not limited to these exemplary aspects.

At 810, an underlay multicast packet is received. For example, inter-area router 420a receives an underlay packet of multicast stream 10, according to some aspects. In some aspects, the underlay packet may contain an underlay header with a source Media Access Control (MAC) address corresponding to network node 415a, a source Internet Protocol (IP) address corresponding to network node 415a, a destination multicast MAC address, a destination multicast IP address, a VLAN value derived by network node 415a, and a VNI value derived by network node 415a.

At 820, the source MAC address of the underlay multicast packet is changed. For example, inter-area router 420a changes the source MAC address of the underlay packet to the MAC address corresponding to inter-area router 420a, according to some aspects. In some aspects, the MAC address corresponding to inter-area router 420a may be a system ID assigned to inter-area router 420a.

At 830, a TTL value associated with the underlay multicast packet is de-incremented by 1. For example, inter-area router 420a de-increments the TTL value associated with the underlay packet of multicast stream 10 to prior to transmitting the underlay packet from area 410 into area 430.

At 840, the underlay multicast packet is transmitted to one or more network nodes in a second area, as determined by the SPF tree. For example, inter-area router 420a transmits the underlay packet to one or more of the network nodes 435 in area 430, according to some aspects. In some aspects, inter-area router 420a may receive a shortest forwarding path determined by the SPF tree. The shortest forwarding path may define a forwarding path of multicast stream 10 in environment 400b. In some aspects, inter-area router 420a transmits the underlay packet into area 430 in accordance with the received the shortest forwarding path determined by the SPF tree.

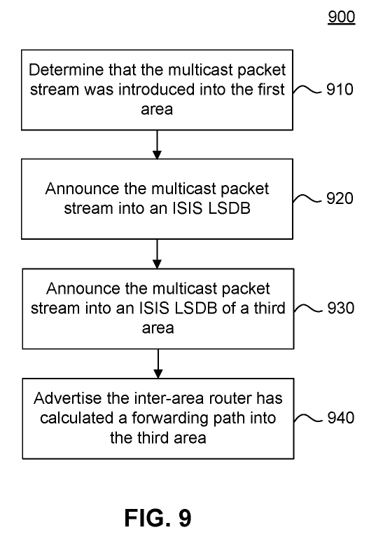

FIG. 9 is a flow chart illustrating method 900 for forwarding an underlay packet of a multicast stream from a first area of network nodes into a second and third areas of network nodes outside of the first area, according to some aspects. Method 900 can be employed in aspects of the multi-area networks described herein, such as multi-area network environments 400a and 400b. Method 900 will be described with reference to the elements enumerated in FIGS. 3, 4A, and 4B; however, method 900 is not limited to these example aspects.

In some aspects, method 900 can be implemented to forward multicast stream traffic across the multiple areas described in multi-area network environments 400a and 400b. For example, method 900 may utilize an inter-area router between a first area and a second area, an inter-area router between the second area and a third area, a set of network nodes in the first area, a set of network nodes in the second area, a set of network nodes in the third area, and an end node in a set of end nodes in the multi-area network fabric As enumerated in environment 400b described in FIG. 4B, inter-area router 420a between areas 410 and 430, inter-area router 440b between areas 430 and 450, network nodes 415 of area 410, network nodes 435 of area 430, network nodes 455 of area 450, and network node 455b will be used as an exemplary inter-area router between a first area and a second area, inter-area router between a second area and a third area, set of network nodes in a first area, set of network nodes in a second area, set of network nodes in a third area, and end node, respectively, to illustrate the features of method 900. However, method 900 is not limited to these exemplary aspects.

At 910, a multicast stream is determined to have been introduced into an area. For example, inter-area router 420a determines that multicast stream 10 was introduced into area 410, according to some aspects. Inter-area router 420a may make said determination by querying the LSDB of area 410 in the ISIS-configured control plane 310.

At 920, the multicast stream is announced into an LSDB of the receiving area. For example, inter-area router 420a announces multicast stream 10 into an LSDB of area 430 in the ISIS-configured control plane 310, according to some aspects. In some aspects, inter-area router 420a may announce the multicast stream 10 into the LSDB of area 430 via a TLV encoding scheme. The TLV data object announced into the LSDB of area 430 may include an overlay source IP address corresponding to host device 405a, an overlay IP multicast group value, an overlay scope VNI value based on a layer 2 or layer 3 instance, and a per-IP-multicast stream data VNI assigned from a per network node reserved range.

At 930, the multicast stream is re-announced into an LSDB of a distant area. For example, inter-area router 420a re-announces multicast stream 10 into an LSDB of area 450 in the ISIS-configured control plane 310, according to some aspects. In some aspects, inter-area router 420a may re-announce multicast stream 10 into other neighboring areas of environment 400b using the TLV data objects announced into the LSDB of area 410 or any other originating area of an overlay IP multicast stream. Furthermore, inter-area router 420a may be configured with a redistribution policy to extend the services contained therein beyond the areas in which it intersects, including areas 410 and 430. For example, inter-area router 420a may compile a list of services, such as overlay routes, IP multicast streams, layer 2 virtual services networks, or a combination thereof, and publish the compiled list of services complying with the redistribution policy in the other areas of environment 400b, such as area 450. Inter-area router 420a may publish the compiled list of services by adding new TLV data objects to the link-state protocol packets of the other areas. In some aspects, the new TLV data object may contain the same elements of the TLV data object described in box 920 and also include the BIP-SA of network node 415a or any other edge node receiving an overlay IP multicast stream.

At 940, a calculated forwarding path into the distant area is advertised. For example, inter-area router 420a advertises a calculated forwarding path into area 450, according to some aspects. In some aspects, inter-area router 420a may calculate a distance metric for network nodes 415. The distance metric may indicate a forwarding route distance from the network nodes 415 to the network nodes 455. The distance metric may refer to the shortest path or cost to traverse multi-area network environment 400b in accordance with the SPF tree of multicast stream 10. In some aspects, inter-area router 420a may input the distance metric for network nodes 415 into the LSDB instance of area 410. In some aspects, inter-area router 420a may determine the distance from one of the network nodes 415 to one of the network nodes 455 is the shortest bridged or routed path, in accordance with the SPF tree of multicast stream 10.

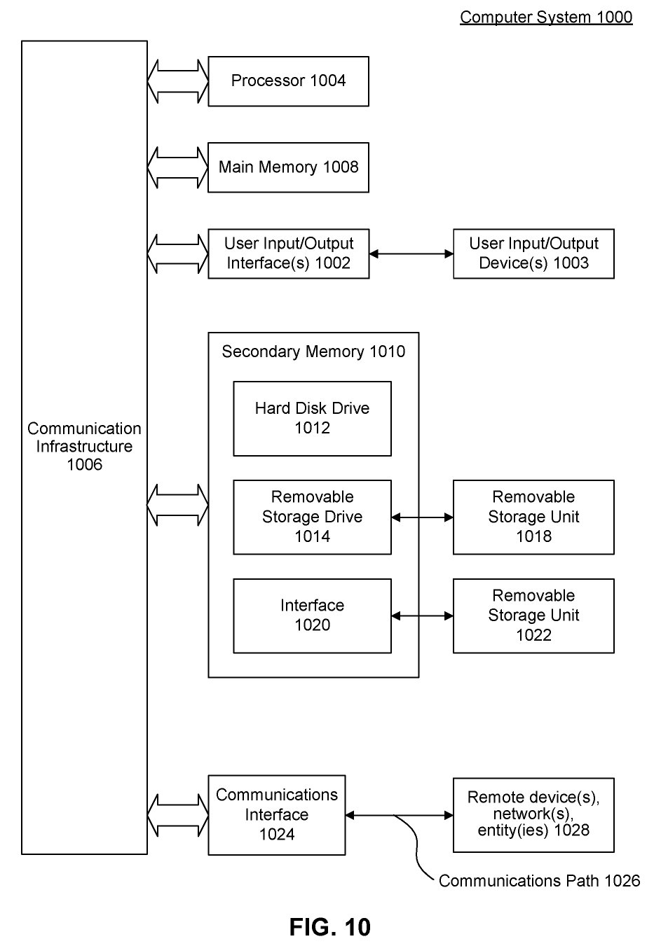

FIG. 10 illustrates a diagram of a general-purpose computer that can be used to perform various aspects of the present disclosure, according to some aspects. Various aspects can be implemented, for example, using one or more well-known computer systems, such as computer system 1000 shown in FIG. 10. One or more computer systems 1000 can be used, for example, to implement any aspect of the disclosure discussed herein, such as control plane environment 300 and IP multicast stream environments 400a and 400b, as well as any combinations and sub-combinations thereof.

Computer system 1000 can include one or more processors (also called central processing units, or CPUs), such as a processor 1004. Processor 1004 can be connected to a communication infrastructure or bus 1006.

Computer system 1000 can also include customer input/output device(s) 1003, such as monitors, keyboards, pointing devices, etc., which can communicate with communication infrastructure 1006 through customer input/output interface(s) 1002.

One or more of processors 1004 can be a graphics processing unit (GPU). In an aspect, a GPU can be a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 1000 can also include a main or primary memory 1008, such as random access memory (RAM). Main memory 1008 can include one or more levels of cache. Main memory 1008 can have stored therein control logic (i.e., computer software) and/or data.

Computer system 1000 can also include one or more secondary storage devices or memory 1010. Secondary memory 1010 can include, for example, a hard disk drive 1012 and/or a removable storage device or drive 1014. Removable storage drive 1014 can be a floppy disk drive, a magnetic tape drive, a compact disk drive, an optical storage device, tape backup device, and/or any other storage device/drive.

Removable storage drive 1014 can interact with a removable storage unit 1018. Removable storage unit 1018 can include a computer usable or readable storage device having stored thereon computer software (control logic) and/or data. Removable storage unit 1018 can be a floppy disk, magnetic tape, compact disk, DVD, optical storage disk, and/ any other computer data storage device. Removable storage drive 1014 can read from and/or write to removable storage unit 1018.

Secondary memory 1010 can include other means, devices, components, instrumentalities or other approaches for allowing computer programs and/or other instructions and/or data to be accessed by computer system 1000. Such means, devices, components, instrumentalities or other approaches can include, for example, a removable storage unit 1022 and an interface 1020. Examples of the removable storage unit 1022 and the interface 1020 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 can further include a communication or network interface 1024. Communication interface 1024 can enable computer system 1000 to communicate and interact with any combination of external devices, external networks, external entities, etc. (individually and collectively referenced by reference number 1028). For example, communication interface 1024 can allow computer system 1000 to communicate with external or remote devices 1028 over communications path 1026, which can be wired and/or wireless (or a combination thereof), and which can include any combination of LANs, WANs, the Internet, etc. Control logic and/or data can be transmitted to and from computer system 1000 via communication path 1026.

Computer system 1000 can also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1000 can be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 can be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas can be used, either exclusively or in combination with known or open standards.

In some aspects, a tangible, non-transitory apparatus or article of manufacture including a tangible, non-transitory computer useable or readable medium having control logic (software) stored thereon can also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000), can cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 10. In particular, aspects can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary aspects of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the invention that others can, by applying knowledge within the skill of the art, readily modify and/or adapt for various applications such specific aspects, without undue experimentation, without departing from the general concept of the present invention. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References herein to “one aspect,” “an aspect,” “an example aspect,” “some aspects,” or similar phrases, indicate that the aspect described can include a particular feature, structure, or characteristic, but every aspect can not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

These and other valuable aspects of the aspects of the present disclosure consequently further the state of the technology to at least the next level. While the disclosed aspects have been described as the best mode of implementing the multi-area SPBX network for overlay IP multicast streams, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the breadth and scope of this disclosure should not be limited by any of the above-described exemplary aspects, but should be defined only in accordance with the following claims and their equivalents.

What is claimed is:

1. A method for forwarding an overlay packet of a multicast stream over a multi-area network comprising a first area including a first set of network nodes and a second area including a second set of network nodes outside of the first area, the method comprising:
receiving, by an edge node in the first set of network nodes and from a host device, the overlay packet of the multicast stream;
encapsulating, by the edge node, the overlay packet into an underlay multicast packet based on a layer 3 virtual network;
creating, by the edge node, a shortest-path forwarding (SPF) tree to one or more receiving devices, wherein the SPF tree comprises a root node corresponding to the edge node, a set of forwarding nodes among the first and second sets of network nodes, and a set of end nodes in the first and second sets of network nodes; and
forwarding, by the edge node and using the set of forwarding nodes, the underlay multicast packet to the set of end nodes.

2. The method of claim 1, wherein encapsulating the overlay packet into the underlay multicast packet based on the layer 3 virtual network further comprises:
adding, by the edge node, an underlay header to the overlay packet, wherein the underlay header comprises a source Media Access Control (MAC) address of the edge node, a source Internet Protocol (IP) address of the edge node, a destination multicast MAC address, a destination multicast IP address, a virtual local area network (VLAN) value derived by the edge node, and a virtual network identifier (VNI) value derived by the edge node.

3. The method of claim 2, further comprising:
assigning, by the edge node, a nickname and the VNI value to the SPF tree, wherein the nickname corresponds to a predefined number of least significant bits of the source IP address of the edge node; and
bridging, by the edge node and using the set of forwarding nodes, the underlay multicast packet over the first and second sets of network nodes based on the nickname assigned to the SPF tree.

4. The method of claim 2, further comprising:
assigning, by the edge node, a Source Group VLAN (SGV) value to the multicast stream, wherein the SGV value comprises the source IP address of the edge node, a group IP address reflecting the VNI value, and the VLAN value; and
routing, by the edge node and using the set of forwarding nodes, the underlay multicast packet over the first and second sets of network nodes based on the SGV value assigned to the SPF tree.

5. The method of claim 1, further comprising:
announcing, by the edge node, the multicast stream into an Intermediate System to Intermediate System (ISIS) link-state database of the first area via a Type-Length-Value encoding scheme, wherein the ISIS link-state database is in a control plane of the multi-area network;
based on announcing the multicast stream into the ISIS link-state database, determining one or more inter-area routers capable of routing the underlay multicast packet into the second area; and
forwarding, using the set of forwarding nodes, the underlay multicast packet to the one or more inter-area routers.

6. The method of claim 1, further comprising:
receiving, by the edge node and from another host device, a second overlay packet of a second multicast stream;
encapsulating, by the edge node, the second overlay packet into a second underlay multicast packet based on the layer 3 virtual network;
creating, by the edge node, a second SPF tree to a second one or more receiving devices, wherein the second SPF tree comprises a second root node corresponding to the edge node, a second set of forwarding nodes among the first and second sets of network nodes, and a second set of end nodes in the first and second sets of network nodes; and
forwarding, by the edge node and using the second set of forwarding nodes, the second underlay multicast packet to the second set of end nodes.

7. The method of claim 1, wherein the multi-area network further comprises a third area including third set of network nodes outside of both the first and second areas and a fourth area including a fourth set of network nodes outside of the first, second, and third areas.

8. A system for forwarding an overlay packet of a multicast stream over a multi-area network comprising a first area including a first set of network nodes and a second area including a second set of network nodes outside of the first area, the system comprising:
an edge node in the first set of network nodes in the multi-area network, the edge node configured to:
receive, from a host device, the overlay packet of the multicast stream;
encapsulate the overlay packet into an underlay multicast packet based on a layer 3 virtual network;
create a shortest-path forwarding (SPF) tree to one or more receiving devices, wherein the SPF tree comprises a root node corresponding to the edge node, a set of forwarding nodes among the first and second sets of network nodes, and a set of end nodes in the first and second sets of network nodes; and
forward, using the set of forwarding nodes, the underlay multicast packet to the set of end nodes.

9. The system of claim 8, wherein to encapsulate the overlay packet into the underlay multicast packet based on the layer 3 virtual network, the edge node is further configured to:
add an underlay header to the overlay packet, wherein the underlay header comprises a source Media Access Control (MAC) address of the edge node, a source Internet Protocol (IP) address of the edge node, a destination multicast MAC address, a destination multicast IP address, a virtual local area network (VLAN) value derived by the edge node, and a virtual network identifier (VNI) value derived by the edge node.

10. The system of claim 9, wherein the edge node is further configured to:
assign a nickname and the VNI value to the SPF tree, wherein the nickname corresponds to a predefined number of least significant bits of an IP address of the edge node; and
bridge, using the set of forwarding nodes, the underlay multicast packet over the first and second sets of network nodes based on the nickname assigned to the SPF tree.

11. The system of claim 9, wherein the edge node is further configured to:
assign a Source Group VLAN (SGV) value to the multicast stream, wherein the SGV value comprises the source IP address of the edge node, a group IP address reflecting the VNI value, and the VLAN value; and
route, using the set of forwarding nodes, the underlay multicast packet over the first and second sets of network nodes based on the SGV value assigned to the SPF tree.

12. The system of claim 8, wherein the edge node is further configured to:
announce the multicast stream into an Intermediate System to Intermediate System (ISIS) link-state database of the first area via a Type-Length-Value encoding scheme, wherein the ISIS link-state database is in a control plane of the multi-area network;
based on announcing the multicast stream into the ISIS link-state database, determining one or more inter-area routers capable of routing the underlay multicast packet into the second area; and
forwarding, using the set of forwarding nodes, the underlay multicast packet to the one or more inter-area routers.

13. The system of claim 8, wherein the edge node is further configured to:
receive, from another host device, a second overlay packet of a second multicast stream;
encapsulate the second overlay packet into a second underlay multicast packet based on the layer 3 virtual network;
create a second SPF tree to a second one or more receiving devices, wherein the second SPF tree comprises a second root node corresponding to the edge node, a second set of forwarding nodes among the first and second sets of network nodes, and a second set of end nodes in the first and second sets of network nodes; and
forward, using the second set of forwarding nodes, the second underlay multicast packet to the second set of end nodes.

14. The system of claim 8, wherein the multi-area network further comprises a third area including third set of network nodes outside of both the first and second areas and a fourth area including a fourth set of network nodes outside of the first, second, and third areas.

15. A non-transitory computer readable medium storing instructions for forwarding an overlay packet of a multicast stream over a multi-area network comprising a first area including a first set of network nodes and a second area including a second set of network nodes outside of the first area that, when executed by an edge node in the first set of network nodes, cause the edge node to perform operations comprising:
receiving, from a host device, the overlay packet of the multicast stream;
encapsulating the overlay packet into an underlay multicast packet based on a layer 3 virtual network;
creating a shortest-path forwarding (SPF) tree to one or more receiving devices, wherein the SPF tree comprises a root node corresponding to the edge node, a set of forwarding nodes among the first and second sets of network nodes, and a set of end nodes in the first and second sets of network nodes; and
forwarding, using the set of forwarding nodes, the underlay multicast packet to the set of end nodes.

16. The non-transitory computer readable medium of claim 15, wherein encapsulating the overlay packet into the underlay multicast packet based on the layer 3 virtual network further comprises:
adding an underlay header to the overlay packet, wherein the underlay header comprises a source Media Access Control (MAC) address of the edge node, a source Internet Protocol (IP) address of the edge node, a destination multicast MAC address, a destination multicast IP address, a virtual local area network (VLAN) value derived by the edge node, and a virtual network identifier (VNI) value derived by the edge node.

17. The non-transitory computer readable medium of claim 16, further comprising:
assigning a nickname and the VNI value to the SPF tree, wherein the nickname corresponds to a predefined number of least significant bits of an IP address of the edge node; and
bridging, using the set of forwarding nodes, the underlay multicast packet over the first and second sets of network nodes based on the nickname assigned to the SPF tree.

18. The non-transitory computer readable medium of claim 16, further comprising:
assigning a Source Group VLAN (SGV) value corresponding to the multicast stream, wherein the SGV value comprises the source IP address of the edge node, a group IP address reflecting the VNI value, and the VLAN value; and
routing, using the set of forwarding nodes, the underlay multicast packet over the first and second sets of network nodes based on the SGV value assigned to the SPF tree.

19. The non-transitory computer readable medium of claim 15, further comprising:
announcing the multicast stream into an Intermediate System to Intermediate System (ISIS) link-state database of the first area via a Type-Length-Value encoding scheme, wherein the ISIS link-state database is in a control plane of the multi-area network;
based on announcing the multicast stream into the ISIS link-state database, determining one or more inter-area routers capable of routing the underlay multicast packet into the second area; and
forwarding, using the set of forwarding nodes, the underlay multicast packet to the one or more inter-area routers.

20. The non-transitory computer readable medium of claim 15, further comprising:
receiving, from another host device, a second overlay packet of a second multicast stream;
encapsulating the second overlay packet into a second underlay multicast packet based on the layer 3 virtual network;
creating a second SPF tree to a second one or more receiving devices, wherein the second SPF tree comprises a second root node corresponding to the edge node, a second set of forwarding nodes among the first and second sets of network nodes, and a second set of end nodes in the first and second sets of network nodes; and
forwarding, using the second set of forwarding nodes, the second underlay multicast packet to the second set of end nodes.
